(19) United States
(12) Patent Application Publication
(10) Pub. No.: US 2003/0122287 A1
(43) Pub. Date: Jul. 3, 2003

(54) Method of manufacturing packaging articles, and a corresponding manufacturing machine

(76) Inventors: Michel Marcel, Villevaude (FR); Christophe Marcel, Villevaude (FR)

Correspondence Address: YOUNG & THOMPSON, 745 SOUTH 23RD STREET 2ND FLOOR, ARLINGTON, VA, 22202

(21) Appl. No.: 10/026,694

(22) Filed: Dec. 27, 2001

(51) Int. Cl. B29C 49/50

(52) U.S. Cl. 264/536; 425/527; 425/310; 264/531

(57) ABSTRACT

This method of manufacturing packaging articles each having a hollow body provided with a neck-forming open end comprises the steps of applying a flat piece of thermoplastic material over the open end of a mold recess, of heating said material, of punching the material by inserting a piston into the mold cavity through its opening so as to form a blank, of blowing the resulting blank against the wall of the mold, and opening the mold. The mold is constituted by an assembly of elements each constituting a matrix for molding a segment of an article, and the mold is opened by separating the elements of each pair. While the mold is being opened, the article is sucked against a bottom element of the mold.

The present invention relates to a method of manufacturing packaging articles and to a corresponding manufacturing machine.

### BACKGROUND OF THE INVENTION

It is intended for manufacturing hollow articles for storing substances, in particular food products or cosmetics, such articles being of the pot or flask type and comprising a hollow body provided with a neck-forming open end, i.e. articles each having a body in which at least some of its sections are greater than the section of its opening.

One of the techniques best suited to making such articles at low cost consists in applying a flat piece of thermoplastic material over an open end of a mold recess, in heating said material, in punching said material by inserting a piston into the mold enclosure through the opening thereof so as to form a blank, in blowing the resulting blank against the wall of the mold, and then in opening the mold.

### OBJECT AND SUMMARY OF THE INVENTION

The object of the invention is to provide a method and apparatus making it possible to manufacture articles of this type at low cost and suitable for being integrated in a manufacturing and packaging line.

The invention thus provides a method of manufacturing articles of the above-specified type, wherein the mold is constituted by an association of separable elements each constituting a matrix for molding a segment of an article, and the mold is opened by separating the elements, and wherein, while the mold is being opened, the article is sucked against a bottom element of the mold.

Thus, control over the article is conserved after the mold has been opened, thereby making it possible to transfer the article to a packaging station, and the quantity of raw material used is limited.

The manufacturing method of the invention can further comprise one or more of the following characteristics taken singly or in any technically feasible combination:

prior to being punched, the material is trimmed by being pressed against a sharp element carried by the mold;

prior to being blown, the blank is trimmed by being pressed against a sharp element carried by the mold; and

after being blown, the blown blank is cooled by causing a cooling fluid to flow in the wall of the mold.

The invention also provides a machine for manufacturing packaging articles, each article having a hollow body provided with a neck-forming open end, the machine being of the type comprising at least one assembly comprising a mold, means for positioning a flat piece of thermoplastic material over an open end of a recess of the mold, means for heating the material, a punch having a piston axially displaceable into the mold from a retracted, rest position in which it is situated outside the mold, into an active, blank-forming position in which it penetrates inside the mold, and means for blowing the resulting blank against the wall of the mold, wherein the mold is constituted by separable elements each constituting a matrix for molding a segment of an article, the elements being associated with one another by drive means for controlling displacement thereof to open and close the mold, and wherein the bottom of the mold is provided with at least one suction tube for connection to suction apparatus for holding an article against said bottom, while the mold is being opened.

This machine can also comprise one or more of the following characteristics:

it includes means for handling articles in order to transfer them from the bottom of the mold to a packaging station;

the mold bottom is provided with channels opening out to the outside in order to enable the air filling the mold to be expelled while the blank is being blown;

it includes trimming means for trimming the flat piece of material or the blown blank; and

the mold includes cooling channels integrated in the wall of the mold for cooling the blown blank and suitable for being connected to a source of cooling fluid.

### BRIEF DESCRIPTION OF THE DRAWINGS

Other characteristics and advantages appear from the following description purely by way of example and made with reference to the accompanying drawings, in which:

FIG. 1 is a diagrammatic section view of a machine of the invention for manufacturing packaging articles, after the step of applying a flat piece of thermoplastic material over the opening of the mold;

FIG. 2 shows the FIG. 1 machine after the blank has been blown; and

FIG. 3 shows the FIG. 1 machine after the mold has been opened.

### MORE DETAILED DESCRIPTION

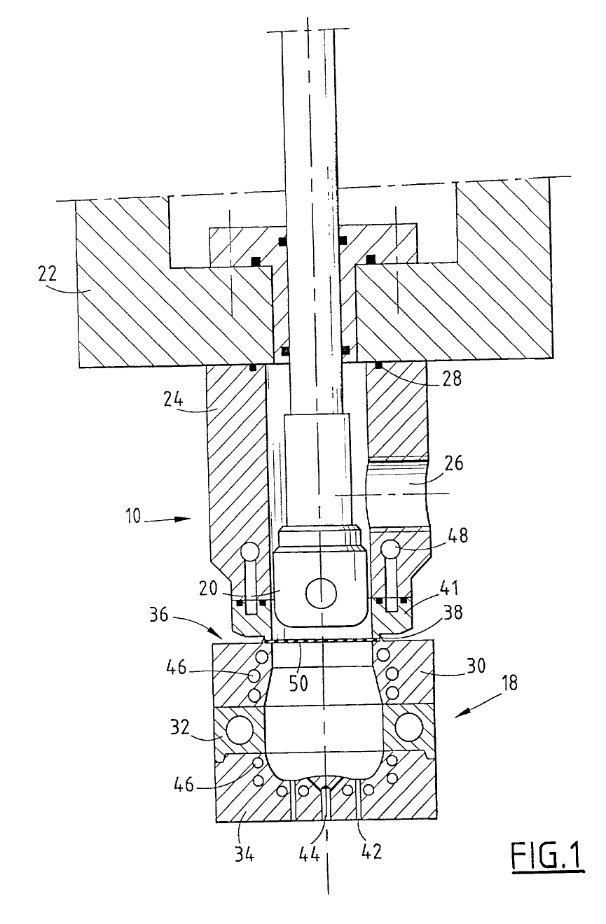

FIGS. 1 to 3 show a machine for manufacturing articles for packaging a product, and designated by overall numeral reference 10.

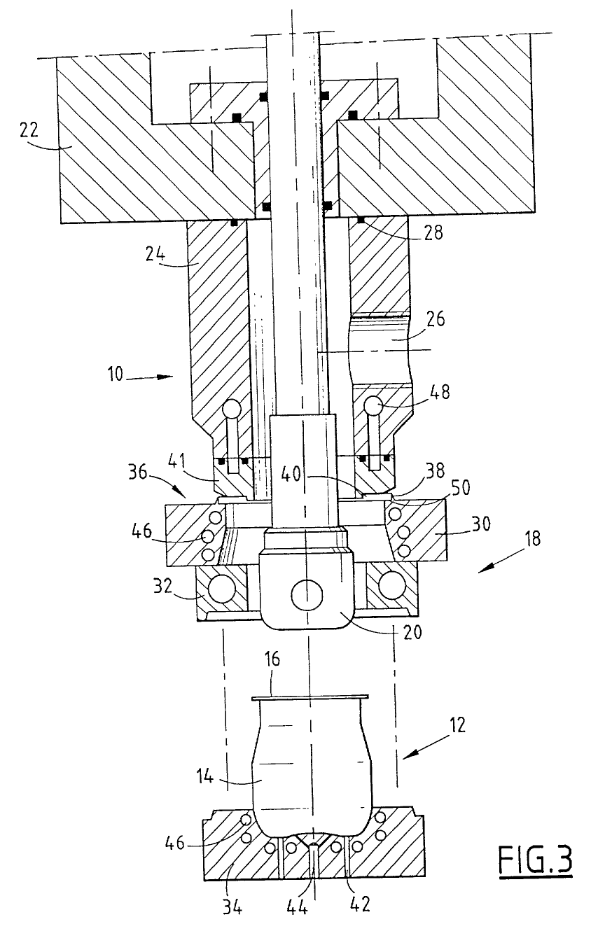

The machine is for manufacturing hollow articles 12 (FIG. 3) of the type comprising a hollow body 14 having a neck-forming open end 16, the machine operating by punching/forming a flat piece of thermoplastic material in the form of a sheet or a strip.

That is to say, it is for making articles having at least some sections that are larger than the sections of the open end 16.

The machine 10 mainly comprises a mold 18 whose internal recess corresponds to the shape of the finished article 12, and a punch comprising a piston 20 associated with drive means (not shown) located in a casing 22.

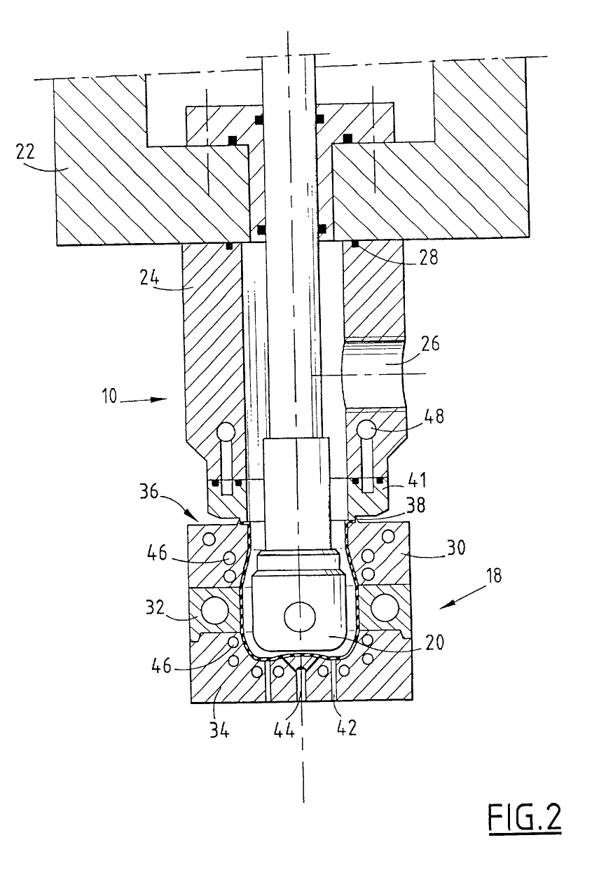

The piston 20 is axially displaceable in a guide cylinder 24 of the casing 22 between a retracted, rest position as shown in FIG. 1, where the piston lies outside the mold 18, and an active, punching position, as shown in FIG. 2, where the piston penetrates into the mold to form a blank.

As can be seen in particular in FIG. 1, the guide cylinder 24 opens out into the mold recess and it is fitted with a duct 26 for feeding air under pressure and suitable for connection to a corresponding feed source (not shown).

Various gaskets such as 28 are located between the cylinder 24 and the remainder of the casing 22, and between the piston 20 and the casing 22, so as to ensure that the assembly is airtight.

As can be seen in FIGS. 1 and 2, the mold 18 is constituted by associating three levels of mold elements 30, 32, and 34 each constituting a matrix for molding a segment of the article and each associated with drive means for causing the mold to be opened and closed (not shown).

These levels 30, 32, and 34 extend downwards in that order relative to the machine.

The top level 30 is constituted by associating a pair of separable mold elements. It is for molding the top portion of an article 12 and is provided, at its top edge 36, with an annular trimmer 38 for co-operating with a seat 40 of complementary shape carried by a counter-mold 41 secured to the guide cylinder 24 for the purpose of trimming a piece of thermoplastic material used for making articles 12, or for trimming said articles once made, as described below.

The intermediate level 32 is annular in shape and is for molding the intermediate portion of articles 12, i.e. the portion having the largest cross-sections.

It is also used for decorating articles and for this purpose it receives, prior to the mold being closed, a decorative adhesive label, for example.

Finally, the bottom level 34 is for molding the bottom of an article 12. It is provided firstly with channels such as 42 enabling the air that originally fills the mold at the beginning of article manufacture to be expelled, and also with at least one suction tube 44 designed to be connected to suction apparatus to hold the article 12 against the bottom 34 after the mold has been opened.

Finally, these figures show that the mold 18 is provided with a network of channels 46 integrated in the mold wall, these channels being for connection to a source for supplying cooling fluid.

One such channel 48 is also provided in the wall constituting the guide cylinder 24 for the piston 20.

The annular trimmer 38 carried by the top level 30 of the mold 18 has a diameter greater than the diameter of the opening to the mold cavity so as to define a shoulder 50 for use in forming a top peripheral rim on the neck 16.

Nevertheless, the inside diameter of the trimmer 38 is smaller than the maximum inside diameter of the mold cavity defined by the intermediate level 32 so as to make it possible for an article 12 to be unmolded in a vertical direction.

The main stages of the method of manufacture implemented by the machine 10 as described above are described below with reference to FIGS. 1 to 3.

During a first stage, the mold is assembled by bringing together the component elements of the top level 30 and by grouping together the three levels 30, 32, and 34.

In this position, the top end edge 36 of the mold 18 is spaced apart from the bottom end of the guide cylinder 34, and in particular from the countermold 41.

A piece of thermoplastic material 50, e.g. constituted by polyethylene, PVC, polyethylene terephthalate, . . . , is delivered by suitable drive means of conventional type over the open end of the mold cavity 18 so as to cover the top level 30 and so as to be positioned on the trimmer 38.

Suitable heater means included in the machine 10 serve to heat the material 50 up to a temperature that is equal to or higher than the elastic limit of the material.

During the following stage, the assembled mold 18 is moved towards the guide cylinder 24 so as to press the trimmer 38 against the seat 40 and thus trim the material 50.

After this step, the machine is in the position shown in FIG. 1, with the piston 20 in its rest position and the material 50 held by the trimmer 38 pressed against the seat 40.

During the following stage, the drive means controlling displacement of the piston 20 are actuated so as to cause the material 50 to be punched by inserting the piston into the mold recess through the opening of the mold, thereby forming a blank.

Thereafter, air under pressure is injected into the mold recess via the duct 26 so as to blow the resulting blank against the wall of the mold. The machine is then in the position shown in FIG. 2.

During this stage, the air filling the mold is expelled via the channels 42.

After the blank has been blown, it is cooled by means of the cooling liquid flowing in the cooling channels 46 so as to bring the temperature of the blown blank down to a temperature below the elastic limit, after which the mold is opened to unmold the article 12, by separating the levels 30, 32, and 34.

To do this, the component elements of the top level 30 are separated and the drive means for controlling displacement of the bottom 34 are actuated so as to move downwards.

The machine is then in the position shown in FIG. 3.

It will be observed that while the mold is opening, the suction apparatus connected to the suction tubes 44 is actuated so as to hold the article 12 against the bottom 34 and enable it to be transferred to a packaging station.

Thus, because of the particular size of the internal section of the intermediate level which allows the neck of the article 12 to pass therethrough, moving the bottom 34 of the mold serves to separate the article 12 from the upper levels 30 and 32.

During a first step, the article is transferred by moving the bottom 34 so as to disengage the article 12, and then during a second step, using handling means (not shown) forming part of the machine 10, e.g. constituted by a fork that takes hold of the neck 16 of the article 12, the article is transferred to a packaging station where the article is filled and then closed.

By way of example, the article can be closed by covering the neck 16 with a peel-off film or by screwing on a cap.

Naturally, if a cap is used, the cavity in the top level 30 of the mold 18 is shaped so as to form a thread on the outside surface of the neck 16.

After the bottom 34 carrying the article 12 has been moved, the intermediate level 32 is preferably transferred to a station where a new decorative adhesive label is placed on the cavity of the intermediate level 32 so as to enable an article 12 to be decorated while its blank is being blown.

In the embodiment described above, the piece of plastics material 50 is trimmed prior to the punching stage. Although this order of operation makes it possible to avoid any shrinkage phenomenon that could give rise to creases in the wall constituting an article 12, it is also possible in a variant to perform the trimming operation after the blank has been blown and before the mold is opened.

It will be understood that the invention as described above enables articles to be made by punching and forming a piece of thermoplastic material from which only the quantity of material required for making the articles is taken. This greatly reduces the cost of manufacturing such articles by reducing the quantity of thermoplastic material that is used.

It will also be understood that such articles can be made under conditions of cleanliness that are compatible with the requirements that apply to the food industry. Under such conditions, clean waste can be reused to make other articles, thereby contributing to reducing manufacturing cost.

Finally, it should be observed that the invention is not limited to the embodiments described. The machine described with reference to FIGS. 1 to 3 has a mold made up of three levels. In a variant, it would be equally possible, depending on the type of article to be made, for the machine to be provided with a mold having some other number of levels.

Similarly, the machine described has a single assembly constituted by the mold and its displacement control means, the means for positioning a flat piece on the mold, the heater means, the punch, and the blow means.

Naturally, to be made compatible with requirements for manufacturing at a high rate of throughput, the machine preferably comprises a plurality of such assemblies operating simultaneously so as to make a plurality of articles simultaneously.

1/ A method of manufacturing packaging articles each having a hollow body with a neck-forming open end, the method comprising the following steps:
applying a flat piece of thermoplastic material over an open end of a mold recess;
heating the material;
punching the material by inserting a piston into the mold cavity through its opening so as to form a blank;
blowing the resulting blank against the wall of the mold; and
opening the mold;
wherein the mold is constituted by an association of separable elements each constituting a matrix for molding a segment of an article, and the mold is opened by separating the elements, and wherein, while the mold is being opened, the article is sucked against a bottom element of the mold.

2/ A method according to claim 1, wherein, prior to being punched, the material is trimmed by being pressed against a sharp element carried by the mold.

3/ A method according to claim 1, wherein, prior to being blown, the blank is trimmed by being pressed against a sharp element carried by the mold.

4/ A method according to claim 1, wherein, after being blown, the blown blank is cooled by causing a cooling fluid to flow in the wall of the mold.

5/ A machine for manufacturing packaging articles, each article having a hollow body provided with a neck-forming open end, the machine being of the type comprising at least one assembly comprising a mold, means for positioning a flat piece of thermoplastic material over an open end of a recess of the mold, means for heating the material, a punch having a piston axially displaceable into the mold from a retracted, rest position in which it is situated outside the mold, into an active, blank-forming position in which it penetrates inside the mold, and means for blowing the resulting blank against the wall of the mold, wherein the mold is constituted by separable elements each constituting a matrix for molding a segment of an article, the elements being associated with one another by drive means for controlling displacement thereof to open and close the mold, and wherein the bottom of the mold is provided with at least one suction tube for connection to suction apparatus for holding an article against said bottom, while the mold is being opened.

6/ A machine according to claim 5, including means for handling articles in order to transfer them from the bottom of the mold to a packaging station.

7/ A machine according to claim 5, wherein the mold bottom is provided with channels opening out to the outside in order to enable the air filling the mold to be expelled while the blank is being blown.

8/ A machine according to claim 5, including trimming means for trimming the flat piece of material or the blown blank.

9/ A machine according to claim 5, wherein the mold includes cooling channels integrated in the wall of the mold for cooling the blown blank and suitable for being connected to a source of cooling fluid.
